(19) United States
(12) Patent Application Publication
(10) Pub. No.: US 2018/0329837 A1
(43) Pub. Date: Nov. 15, 2018

(54) INPUT/OUTPUT DIRECTION DECODING IN MIXED VGPIO STATE EXCHANGE

(71) Applicant: QUALCOMM Incorporated, San Diego, CA (US)

(72) Inventors: Lalan Jee MISHRA, San Diego, CA (US); Richard Dominic WIETFELDT, San Diego, CA (US); Mohit Kishore PRASAD, San Diego, CA (US)

(21) Appl. No.: 15/950,955

(22) Filed: Apr. 11, 2018

Related U.S. Application Data
(60) Provisional application No. 62/504,438, filed on May 10, 2017.

(51) Int. Cl. G06F 13/10; G06F 13/20; G06F 13/42

(52) U.S. Cl. CPC G06F 13/102; G06F 13/105; G06F 2213/0016; G06F 13/4282; G06F 13/20

(57) ABSTRACT

Systems, methods, and apparatus for communication virtualized general-purpose input/output (GPIO) signals over a serial communication link. A method performed at a transmitting device coupled to a communication link includes maintaining in a first register, a plurality of virtual general-purpose input/output (VGPIO) bits representing state of a one or more output GPIO pins at least one bit representative of state of an input GPIO pin of the first device, receiving first VGPIO state information directed to the first register, writing or refraining from writing a first set of bits of the first VGPIO state information to the first register based on the value of corresponding bits of a second register. The second set of bits may be directed to the one or more bits representative of state of output GPIO pins.

### PRIORITY CLAIM

This application claims priority to and the benefit of U.S. Provisional Patent Application Ser. No. 62/504,438 filed in the U.S. Patent Office on May 10, 2017, the entire content of this application being incorporated herein by reference as if fully set forth below in its entirety and for all applicable purposes.

### TECHNICAL FIELD

The present disclosure relates generally to serial communication and input/output pin configuration and, more particularly, to transmission of virtual general-purpose input/output data transmitted in groups of bits containing both input and output state information.

### BACKGROUND

Mobile communication devices may include a variety of components including circuit boards, integrated circuit (IC) devices and/or System-on-Chip (SoC) devices. The components may include processing devices, user interface components, storage and other peripheral components that communicate through a shared data communication bus, which may include a serial bus or a parallel bus. General-purpose serial interfaces known in the industry include the Inter-Integrated Circuit (I2C or I²C) serial bus and its derivatives and alternatives, including interfaces and protocols defined by the Mobile Industry Processor Interface (MIPI) Alliance, such as I3C, system power management interface (SPMI), and the Radio Frequency Front-End (RFFE) interfaces and protocols.

In one example, the I2C serial bus is a serial single-ended computer bus that was intended for use in connecting low-speed peripherals to a processor. Some interfaces provide multi-master buses in which two or more devices can serve as a bus master for different messages transmitted on the serial bus. In another example, the RFFE interface defines a communication interface for controlling various radio frequency (RF) front-end devices, including power amplifier (PA), low-noise amplifiers (LNAs), antenna tuners, filters, sensors, power management devices, switches, etc. These devices may be collocated in a single IC device or provided in multiple IC devices. In a mobile communications device, multiple antennas and radio transceivers may support multiple concurrent RF links.

In many instances, a number of command and control signals are employed to connect different component devices in mobile communication devices. These connections consume precious general-purpose input/output (GPIO) pins within the mobile communication devices and it would be desirable to virtualize the physical interconnects to obtain data representations transmitted over existing serial data links. However, conventional serial data links are associated with latencies that may not satisfy timing requirements for physical command and control signals, particularly in real-time embedded system applications supported by mobile communication devices that define firm transmission deadlines.

As mobile communication devices continue to include a greater level of functionality, improved serial communication techniques are needed to support transmission of mixed virtual GPIO state information between peripherals and application processors.

### SUMMARY

Certain aspects of the disclosure relate to systems, apparatus, methods and techniques that can provide optimized low-latency communications between different devices such that GPIO pins may be carried as virtual signals. A virtual GPIO finite state machine (VGI FSM) is provided that can consolidate GPIO state information from multiple sources and distribute the state information to one or more devices over a data communication bus. In one aspect, the consolidated GPIO state information includes information corresponding to input and output GPIO pins.

In various aspects of the disclosure, a method performed at a transmitting device includes maintaining a plurality of virtual general-purpose input/output (VGPIO) bits in a first register, each VGPIO bit representing state of a physical general-purpose input/output (GPIO) pin in a first device. The plurality of VGPIO bits may include one or more bits representative of state of output GPIO pins of the first device and at least one bit representative of state of an input GPIO pin of the first device. The method may further include receiving first VGPIO state information from a serial bus, the first VGPIO state information being directed to the first register, writing a first set of bits of the first VGPIO state information to the first register when corresponding bits of a second register are configured with a first logic state, and refraining from writing a second set of bits of the first VGPIO state information to the first register when corresponding bits of the second register are configured with a second logic state. The second set of bits may be directed to the one or more bits representative of state of output GPIO pins. In certain examples, the serial bus may be operated in accordance with an I3C, SPMI, or RFFE protocol.

In certain aspects, the method includes configuring the second register with a first masking value that corresponds to a configuration of input GPIO pins and output GPIO pins for which state is represented by the first register. The second register may be configured during initialization of the first device.

In some aspects, the first VGPIO state information is received from a second device. The second device may include a third register configured with a plurality of mask bits. Each mask bit may correspond to a GPIO pin of the second device. The third register may be configured with a mask value operable to prevent bits of second VGPIO state information from being written to a VGPIO register of the second device that maintains state of output GPIO pins of the second device. The method may include transmitting the second VGPIO state information from the first device over the serial bus to the second device. The second VGPIO state information may include content of the first register. The third register may be configured with a value that is a logical inversion of a value used to configure the second register.

In various aspects of the disclosure, an apparatus includes a first register adapted to maintain a plurality of VGPIO bits, each VGPIO bit representing state of a physical GPIO pin. The plurality of VGPIO bits may include one or more bits representative of state of output GPIO pins of the apparatus and at least one bit representative of state of an input GPIO pin of the apparatus. The apparatus may include a second register configured with a plurality of mask bits, each mask bit corresponding to one of the plurality of VGPIO bits, a bus interface configured to receive VGPIO state information from a serial bus, the VGPIO state information being directed to the first register, and a masking circuit adapted to prevent bits of the VGPIO state information directed to the one or more bits representative of the state of output GPIO pins from being written to the first register. The serial bus may be operated in accordance with an I3C, SPMI, or RFFE protocol.

In one aspect, each bit of the second register that is configured to have a first logic state enables a corresponding bit of the VGPIO state information to be written to the first register, and each bit of the second register that is configured to have a second logic state prevents a corresponding bit of the VGPIO state information to be written to the first register. The second register may be configured during initialization of the apparatus.

In some aspects, the VGPIO state information is received from an integrated circuit (IC) device coupled to the serial bus. The VGPIO state information may represent state of output GPIO pins of the IC device. The IC device may include a third register configured with a plurality of mask bits, each mask bit corresponding to one of the output GPIO pins of the IC device or an input GPIO pin of the IC device. Bit-settings of the third register may operate to prevent VGPIO bits transmitted by the apparatus from modifying bits of VGPIO state information representative of the state of output GPIO pins of the IC device. The third register may be configured with a value that is a logical inversion of a value used to configure the second register.

In various aspects, an apparatus includes a serial bus, and two IC devices coupled to the serial bus, each IC device including a first register adapted to maintain a first plurality of VGPIO bits, each bit representing state of a physical GPIO terminal in the IC device. The first plurality of VGPIO bits may include one or more bits representative of output GPIO terminals in the IC device and at least one bit representative of an GPIO terminal in the first IC device. Each IC device may include a second register configured with a plurality of mask bits, each mask bit corresponding to one of the first plurality of VGPIO bits, a bus interface configured to receive VGPIO state information directed to the first register from the serial bus, the VGPIO state information including a second plurality of VGPIO bits that includes one or more bits representative of output GPIO terminals in a different IC device, and a masking circuit adapted to prevent the one or more bits representative of the output GPIO terminals in the integrated circuit device from being overwritten by the second plurality of VGPIO bits.

In one aspect, the two IC devices are configured to transmit content of their respective first registers in VGPIO state information transmitted over the serial bus. The second registers of the two IC devices are configured with two different values that are logical inversions of each other. The output GPIO terminals in a first IC device correspond to the input GPIO terminals in a second IC device. The input GPIO terminals in the first IC device correspond to the output GPIO terminals in the second IC device.

In various aspects of the disclosure, a processor readable storage medium is disclosed. The storage medium may be a non-transitory storage medium and may store code that, when executed by one or more processors, causes the one or more processors to store and/or maintain a plurality of VGPIO bits in a first register, each VGPIO bit representing state of a physical GPIO pin in a first device. The plurality of VGPIO bits may include one or more bits representative of state of output GPIO pins of the first device and at least one bit representative of state of an input GPIO pin of the first device. The code may include code for receiving first VGPIO state information from a serial bus, the first VGPIO state information being directed to the first register, writing a first set of bits of the first VGPIO state information to the first register when corresponding bits of a second register are configured with a first logic state, and refraining from writing a second set of bits of the first VGPIO state information to the first register when corresponding bits of the second register are configured with a second logic state. The second set of bits may be directed to the one or more bits representative of state of output GPIO pins.

In certain aspects, the instructions cause the one or more processors to configure the second register with a first masking value that corresponds to a configuration of input GPIO pins and output GPIO pins for which state is represented by the first register. The second register may be configured during initialization of the first device.

In certain aspects, the first VGPIO state information is received from a second device. The second device includes a third register configured with a plurality of mask bits, each mask bit corresponding to a GPIO pin of the second device. The third register may be configured with a mask value operable to prevent bits of second VGPIO state information from being written to a VGPIO register of the second device that maintains state of output GPIO pins of the second device.

In certain aspects, the second VGPIO state information includes content of the first register. The third register may be configured with a value that is a logical inversion of a value used to configure the second register.

In certain aspects, the instructions cause the one or more processors to receive input VGPIO state information directed to the at least one bit representative of state of the input GPIO pin, and drive the input GPIO pin in accordance with the input VGPIO state information.

### BRIEF DESCRIPTION OF THE DRAWINGS

FIG. 1 illustrates an apparatus employing a data link between IC devices that is selectively operated according to one of a plurality of available standards.

FIG. 2 illustrates a system architecture for an apparatus employing a data link between IC devices.

FIG. 3 illustrates a device that employs an RFFE bus to couple various radio frequency front-end devices.

FIG. 4 illustrates a device that employs an SPMI bus to couple various devices in accordance with certain aspects disclosed herein.

FIG. 5 illustrates a device that employs an I3C bus to couple various front-end devices in accordance with certain aspects disclosed herein.

FIG. 6 illustrates an apparatus that includes an Application Processor and multiple peripheral devices that may be adapted according to certain aspects disclosed herein.

FIG. 7 illustrates an apparatus that has been adapted to support Virtual GPIO in accordance with certain aspects disclosed herein.

FIG. 8 illustrates examples of VGI broadcast frames according to certain aspects disclosed herein.

FIG. 9 illustrates examples of VGI directed frames according to certain aspects disclosed herein.

FIG. 10 illustrates configuration registers that may be associated with a physical pin according to certain aspects disclosed herein.

FIG. 11 illustrates the transmission of mixed VGPIO state information between devices.

FIG. 12 illustrates a system adapted in accordance with certain aspects disclosed herein to avoid output VGPIO state corruption at the receiving device when mixed VGPIO state information is transmitted between devices.

FIG. 13 illustrates one example of an apparatus employing a processing circuit that may be adapted according to certain aspects disclosed herein.

FIG. 14 is a first flowchart illustrating certain operations of an application processor adapted in accordance with certain aspects disclosed herein.

FIG. 15 illustrates a first example of a hardware implementation for an apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Overview

Devices that include multiple SoC and other IC devices often employ a shared communication interface that may include a serial bus or other data communication link to connect processors with modems and other peripherals. The serial bus or other data communication link may be operated in accordance with one or more standards or protocols. In one example, a serial bus may be operated in accordance with I2C, I3C, SPMI and/or RFFE protocols. According to certain aspects disclosed herein, the signaling state of a GPIO pin, trace, connector or terminal may be virtualized into GPIO state information that may be transmitted over a data communication link.

Virtualized GPIO state information may be transmitted over a variety of types of communication link, including communication links that include, wired links, wireless links and/or combinations of wired and wireless links. In one example, virtualized GPIO state information can be packetized or otherwise formatted for transmission over wireless networks including Bluetooth, Wireless LAN, cellular networks, etc. Examples involving wired communication links are described herein to facilitate understanding of certain aspects. These aspects invariably apply to implementations in which transmission of virtualized GPIO state information includes transmission over radio frequency (RF) networks.

A number of different protocol schemes may be used for communicating information over communication links. Existing protocols have well-defined and immutable structures in the sense that their structures cannot be changed to optimize transmission latencies based on variations in use cases, and/or coexistence with other protocols, devices and applications. It is an imperative of real-time embedded systems that certain deadlines must be met. In certain real-time applications, paramount importance may be placed on meeting transmission deadlines. In one example, it can be difficult or impossible to guarantee optimal latency under all use cases when a common bus supports different protocols. In some examples, an I2C, I3C, SPMI or RFFE serial communication bus may be used to tunnel different protocols with different latency requirements, different data transmission volumes and/or different transmission schedules. In another example, high-latency virtualized GPIO data available for transmission to multiple devices may include virtualized GPIO data that is written to one device and read from another device, necessitating multiple transmissions in conventional system. Each transmission by a source device can increase bus latency.

Certain aspects disclosed herein provide methods, circuits and systems that are adapted to enable a device to consolidate GPIO state information for both input and output GPIO state and to transmit mixed both input and output GPIO state in a single payload, byte or word while optimizing latency associated with the communication link.

Examples of Apparatus that Employ Serial Data Links

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similarly functioning device.

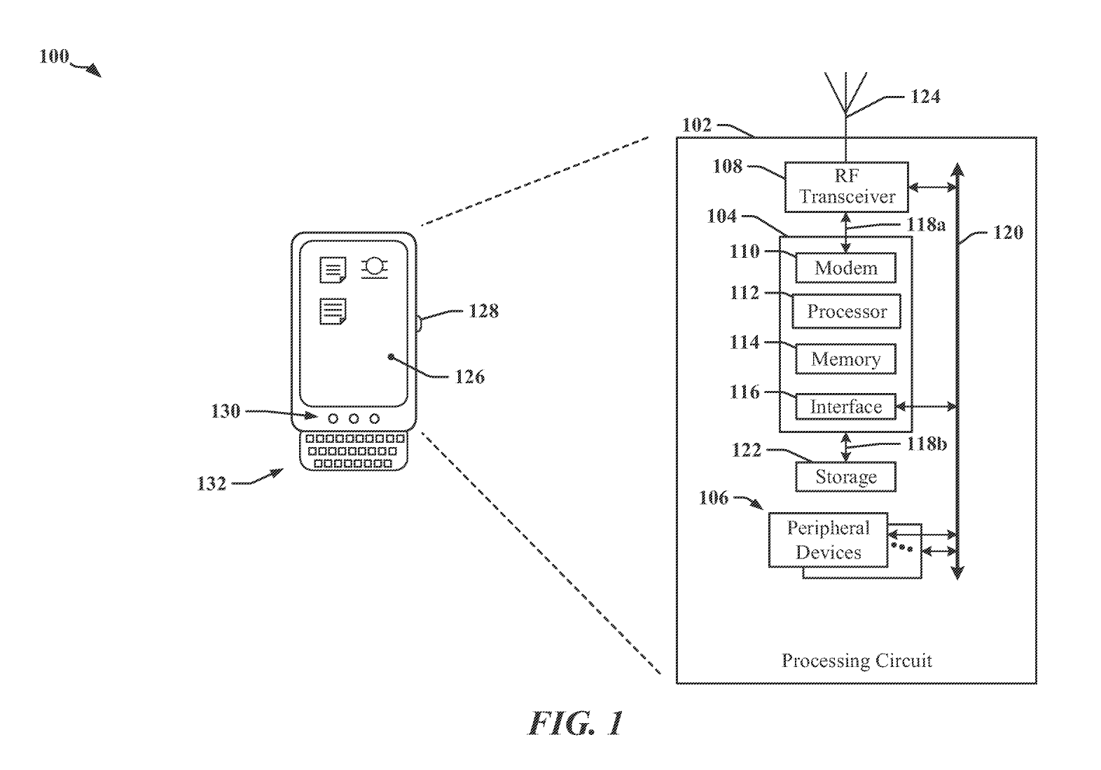

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include some combination of instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

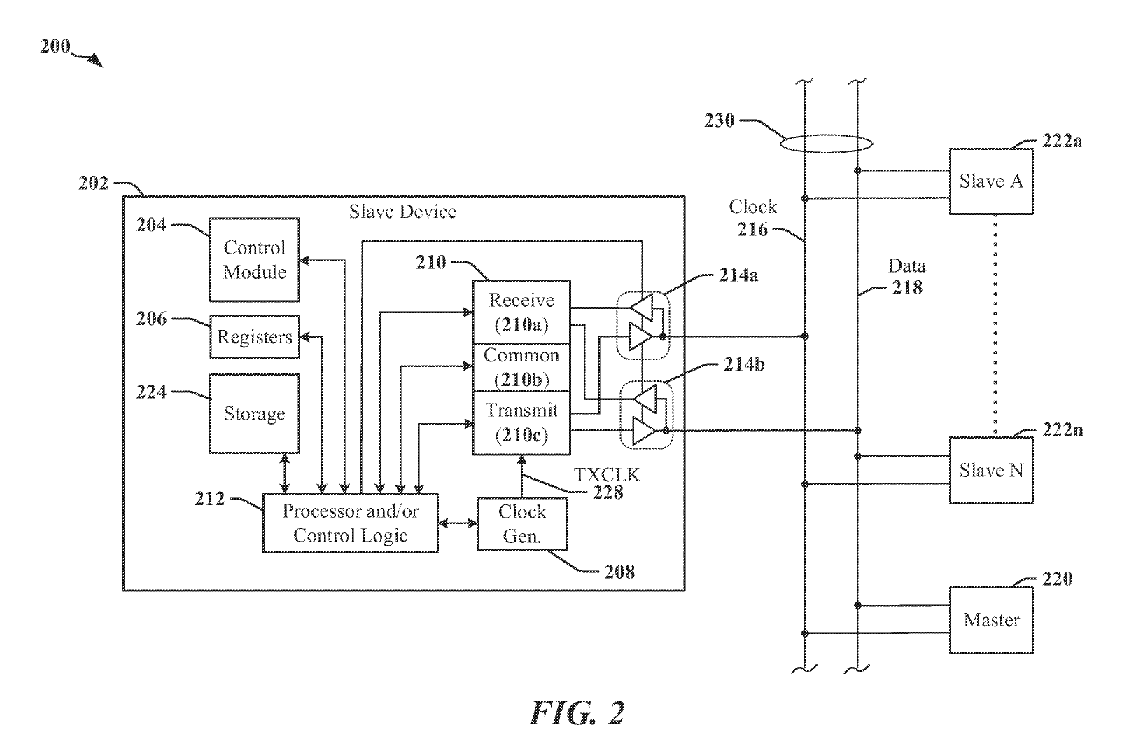

FIG. 2 illustrates certain aspects of an apparatus 200 that includes multiple devices 202, 220 and 222a-222n connected to a serial bus 230. The serial bus 230 may be operated in accordance with a protocol such as an I2C, I3C, SPMI, and/or RFFE protocol. The devices 202, 220 and 222a-222n may include one or more semiconductor IC devices, such as an applications processor, SoC or ASIC. Each of the devices 202, 220 and 222a-222n may include, support or operate as a modem, a signal processing device, a display driver, a camera, a user interface, a sensor, a sensor controller, a media player, a transceiver, and/or other such components or devices. Communications between devices 202, 220 and 222a-222n over the serial bus 230 is controlled by a bus master 220. Certain types of bus can support multiple bus masters 220.

The apparatus 200 may include multiple devices 202, 220 and 222a-222n that communicate when the serial bus 230 is operated in accordance with I2C, I3C or other protocols. At least one device 202, 222a-222n may be configured to operate as a slave device on the serial bus 230. In one example, a slave device 202 may be adapted to provide a control function 204. In some examples, the control function 204 may include circuits and modules that support a display, an image sensor, and/or circuits and modules that control and communicate with one or more sensors that measure environmental conditions. The slave device 202 may include configuration registers 206 or other storage 224, control logic 212, a transceiver 210 and line drivers/receivers 214a and 214b. The control logic 212 may include a processing circuit such as a state machine, sequencer, signal processor or general-purpose processor. The transceiver 210 may include a receiver 210a, a transmitter 210c and common circuits 210b, including timing, logic and storage circuits and/or devices. In one example, the transmitter 210c encodes and transmits data based on timing in one or more signals 228 provided by a clock generation circuit 208.

Two or more of the devices 202, 220 and/or 222a-222n may be adapted according to certain aspects and features disclosed herein to support a plurality of different communication protocols over a common bus, which may include an I2C and/or I3C protocol. For example, devices that communicate using the I2C protocol can coexist on the same 2-wire interface with devices that communicate using I3C protocols. In one example, the I3C protocols may support a mode of operation that provides a data rate between 6 megabits per second (Mbps) and 16 Mbps with one or more optional high-data-rate (HDR) modes of operation that provide higher performance. The I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 230, in addition to data formats and aspects of bus control. I2C and I3C protocols may define direct current (DC) characteristics affecting certain signal levels associated with the serial bus 230, and/or alternating current (AC) characteristics affecting certain timing aspects of signals transmitted on the serial bus 230. In some examples, a 2-wire serial bus 230 transmits data on a first wire 218 and a clock signal on a second wire 216. Some I3C protocols enable data to be encoded in the signaling state, or transitions in combined signaling state of the first wire 218 and the second wire 216.

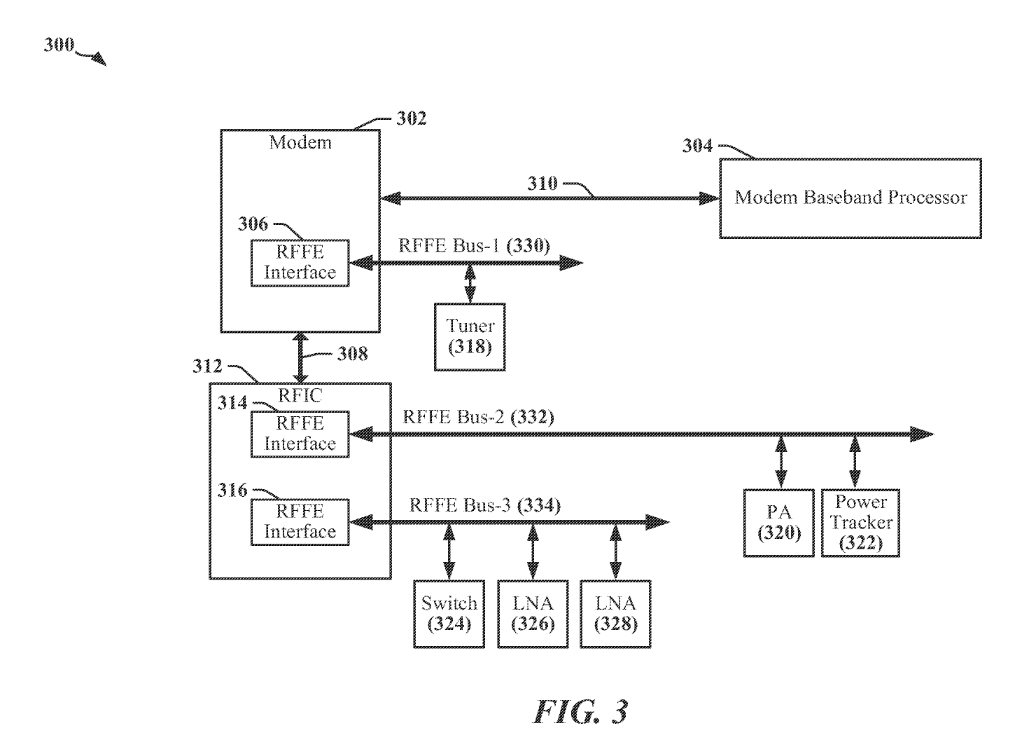

FIG. 3 illustrates an example of bus operated in accordance with RFFE protocols in a system 300 that may be implemented in a chipset, one or more SoCs and/or other configuration of devices. The system 300 employs multiple RFFE buses 330, 332, 334 that can support communication between and with various RF front-end devices 318, 320, 322, 324, 326 328. In this system 300, a modem 302 includes an RFFE interface 306 that can couple the modem 302 to a first RFFE bus 330. The modem 302 may communicate with a baseband processor 304 and an RFIC 312 through one or more communication links 308, 310. The system 300 may be embodied in one or more of a mobile communication device, a mobile telephone, a mobile computing system, a mobile telephone, a notebook computer, a tablet computing device, a media player, a gaming device, a drone, a wearable computing and/or communications device, an appliance, or the like.

In various examples, the system 300 may include one or more baseband processors 304, modems 302, RFICs 312, multiple communications links 308, 310, multiple RFFE buses 330, 332, 334 and/or other types of buses. The device 302 may include other types of processors, circuits, modules and/or buses. The system 300 may be configured for various operations and/or different functionalities. In the system 300 illustrated in FIG. 3, the modem 302 is coupled to an RF tuner 318 through its RFFE interface 306 and the first RFFE bus 330. The RFIC 312 may include one or more RFFE interfaces 314, 316, controllers, state machines and/or processors that configure and control certain aspects of the RF front-end. The RFIC 312 may communicate with a PA 320 and a power tracking module 322 through a first of its RFFE interfaces 314 and the second RFFE bus 332. The RFIC 312 may communicate with a switch 324 and one or more LNAs 326, 328 through a second of its RFFE interfaces 316 and the third RFFE bus 334.

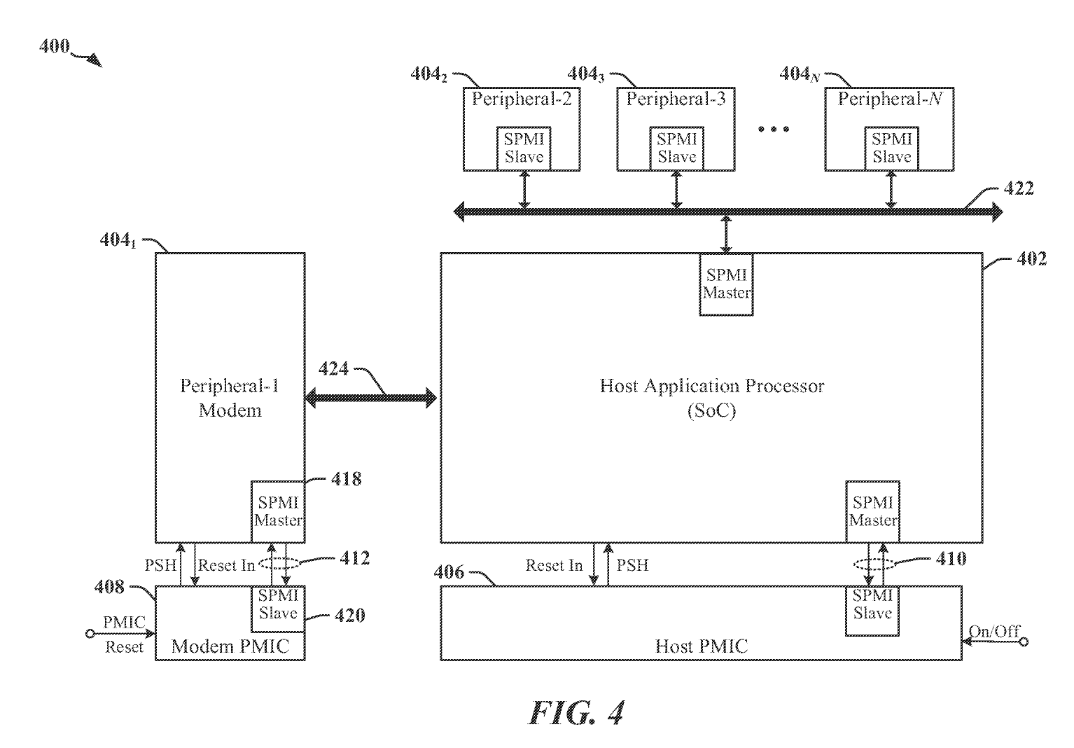

The MIPI Alliance system power management interface (SPMI) specifies a hardware interface that may be implemented between baseband or application processors and peripheral components to support a variety of data communication functions including data communication related to power management operations. FIG. 4 illustrates an example of a system 400 which includes data communication links 410, 412, where each of the data communication links 410, 412 is configured as a two-wire serial bus operated in accordance with SPMI protocols. In one example, a first data communication link 410 may be used to connect an integrated power controller of an application processor 402 with a voltage regulation system in a first power management integrated circuit (PMIC 406), and a second data communication link 412 may be used to connect an integrated power controller of a modem 404₁ with a voltage regulation system in a second PMIC 408. The data communication links 410, 412 can be used to accurately monitor and control processor performance levels required for a given workload or application and dynamically control the various supply voltages in real time based on the performance levels. The data communication links 410, 412 can be used to carry other types of data between the application processor 402 and the first PMIC 406 and/or between the modem 404₁ and the second PMIC 408. SPMI data communication links may be implemented as multi-drop serial links to connect a variety of different devices and to carry other types of data. Some SPMI data communication links may be optimized for real-time power management functions. Some SPMI data communication links may be may be used as a shared bus that provides high-speed, low-latency connection for devices, where data transmissions may be managed, according to priorities assigned to different traffic classes.

In the system 400 illustrated in FIG. 4, the application processor 402 that may serve as a host device on various data communication links 410, 412, 422 and/or 424 which couple the application processor 402 with multiple peripherals 404₁-404_{N}, and the PMIC 406. The application processor 402 may be coupled to each of the peripherals 404₁-404_{N} using different types of data communication protocols. The data communication links 422, 424 may be operated in accordance with protocols such as the RFFE, SPMI, I3C protocols. In some implementations, at least one of the data communication link 422 and/or 424 may include a serial bus operated in accordance with SPMI protocols that can provide low-latency communications between the application processor 402 and certain peripherals 404₁-404_{N}. In some examples, the application processor 402 and the modem 404₁ may be coupled to respective PMICs 406, 408 using power management interfaces implemented using SPMI masters 414, 418. The SPMI masters 414, 418 communicate with corresponding SPMI slaves 416, 420 provided in the PMICs 406, 408 to facilitate real-time control of the PMICs 406, 408.

Bus latency can affect the ability of a serial bus to handle high-priority, real-time and/or other time-constrained messages. Low-latency messages, or messages requiring low bus latency, may relate to or carry sensor status, device-generated real-time events and virtualized general-purpose input/output (GPIO). In one example, bus latency may be measured as the time elapsed between a message becoming available for transmission and the delivery of the message or, in some instances, commencement of transmission of the message. Other measures of bus latency may be employed. Bus latency typically includes delays incurred while higher priority messages are transmitted, interrupt processing, the time required to terminate a transaction in process on the serial bus, the time to transmit commands causing bus turnaround between transmit mode and receive mode, bus arbitration and/or command transmissions specified by protocol.

A virtual GPIO message is one example of low-latency messages. Mobile communication devices, and other devices that are related or connected to mobile communication devices, increasingly provide greater capabilities, performance and functionalities. In many instances, a mobile communication device incorporates multiple IC devices that are connected using a variety of communication links.

Transmitting Virtual GPIO State Over a Serial Bus

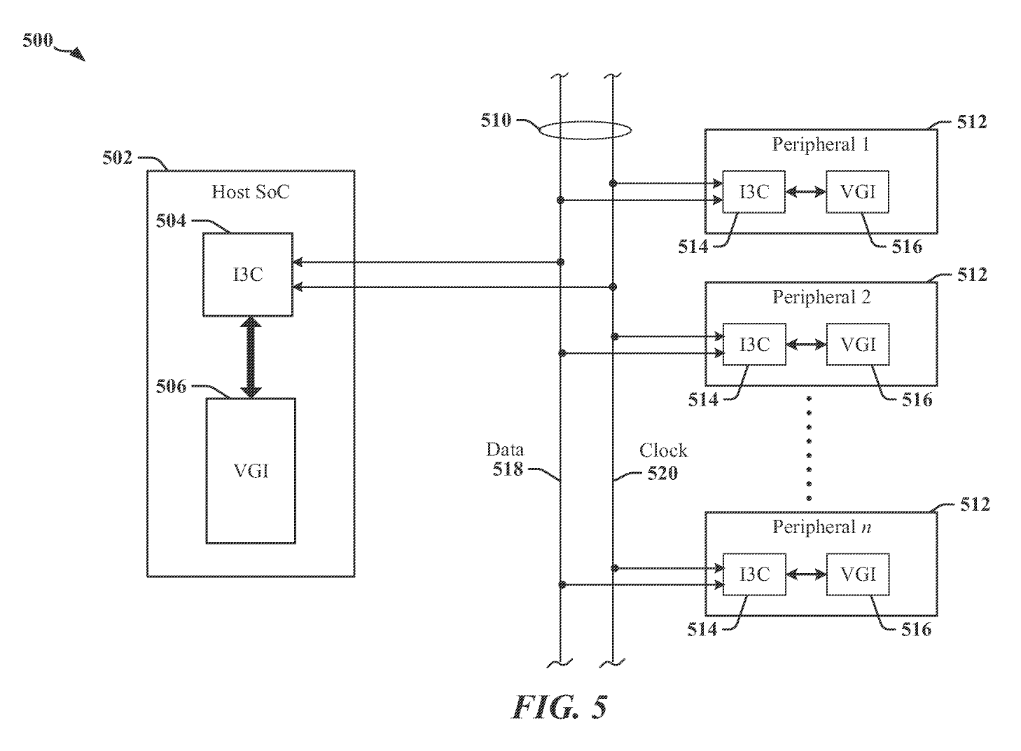

FIG. 5 illustrates an example of an apparatus 500 that uses a multi-wire serial bus 510 to couple various devices including a host SoC 502 and a number of peripheral devices 512. It will be appreciated that certain concepts disclosed herein apply equally to communication links operated in accordance with various protocols, including I2C, I3C, RFFE and SPMI protocols. The host SoC 502 may include a virtual GPIO finite state machine (VGI FSM 506) and a bus interface 504, where the bus interface 504 cooperates with corresponding bus interfaces 514 in the peripheral devices 512 to provide a communication link between the host SoC 502 and the peripheral devices 512. Each peripheral device 512 includes a VGI FSM 516. Communications between the host SoC 502 and a peripheral device 512 may be serialized and transmitted over the multi-wire serial bus 510 in accordance with an I2C, I3C, RFFE and/or SPMI protocol. In some examples, the multi-wire serial bus 510 may be operated as an I3C bus and/or may encode data in a data signal transmitted over a data wire 518 in accordance with timing information provided by a clock signal over a clock wire 520. In certain examples, the multi-wire serial bus 510 may encode data in symbols that control signaling state of the data wire 518 and clock wire 520 with timing/clock information encoded in transitions between signaling state that occur between consecutive symbols.

The virtual GPIO state transmitted over a serial link may relate to physical GPIO pins, connectors, traces, wires, etc., events and/or control signals. The virtual GPIO state may be transmitted over a serial bus, including when the virtual GPIO state represents events or state of physical GPIO pins and signals configured for use with a physical communication link where the virtual GPIO state is transmitted over the serial bus. Mobile communication devices, and other devices that are related or connected to mobile communication devices increasingly provide greater capabilities, performance and functionalities. In many instances, a mobile communication device incorporates multiple IC devices that are configured for connection using a variety of communications links.

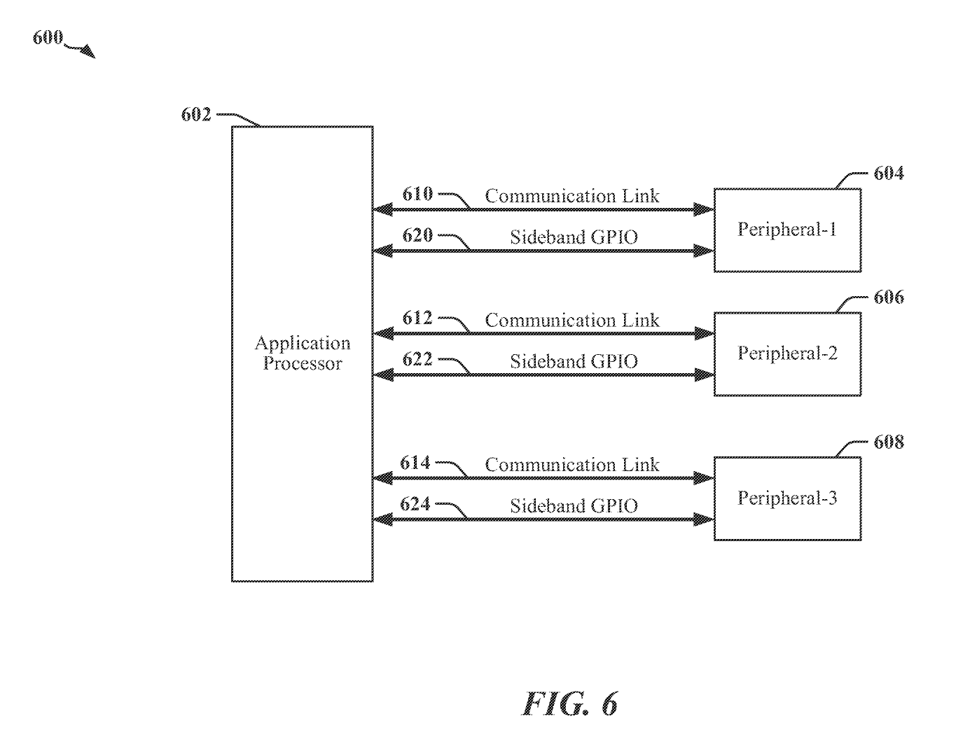

FIG. 6 illustrates a conventional apparatus 600 that includes an Application Processor 602 and multiple peripheral devices 604, 606, 608. In the example, each peripheral device 604, 606, 608 communicates with the Application Processor 602 over a respective communication link 610, 612, 614 operated in accordance with mutually different protocols. Communication between the Application Processor 602 and each peripheral device 604, 606, 608 may involve additional wires that carry control or command signals between the Application Processor 602 and the peripheral devices 604, 606, 608. These additional wires may be referred to herein as sideband general-purpose input/output (sideband GPIO 620, 622, 624), and in some instances the number of connections needed for sideband GPIO 620, 622, 624 can exceed the number of connections used for a communication link 610, 612, 614.

The term “GPIO pin” or “GPIO terminal” may be used herein to refer to physical generic pins, connectors, wires, traces, pads, and/or terminals that may be used to interconnect circuits and/or devices. In some instances, GPIO pins and connections between GPIO pins may be defined by design or may be customized or repurposed for particular applications or device configurations. For example, a GPIO pin may be programmable to function as an output pin, an input pin or a bidirectional pin, in accordance with application needs. In one example, the Application Processor 602 may assign and/or configure a number of GPIO pins to conduct handshake signaling or inter-processor communication (IPC) with a peripheral device 604, 606, 608 such as a modem. When handshake signaling is used, sideband signaling may be symmetric, where signaling is transmitted and received by the Application Processor 602 and a peripheral device 604, 606, 608. With increased device complexity, the increased number of GPIO pins used for IPC communication may significantly increase manufacturing cost and limit GPIO availability for other system-level peripheral interfaces.

According to certain aspects, the state of physical GPIO, including GPIO pins associated with a communication link, may be captured and virtualized, serialized and transmitted over a data communication link. In one example, captured physical GPIO state may be transmitted over a serial bus in packets that are identified by command codes and/or control information, which may indicate packet content (including payload type) and/or destination.

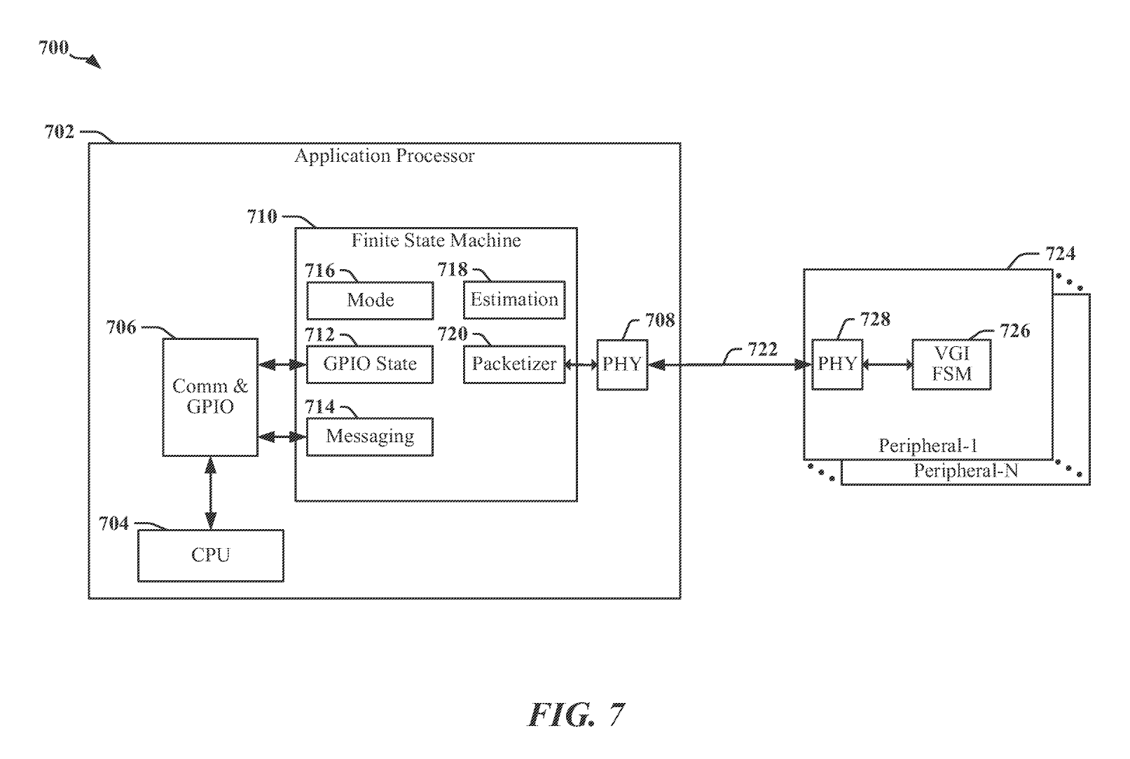

FIG. 7 illustrates an apparatus 700 that is adapted to support Virtual GPIO (VGI) in accordance with certain aspects disclosed herein. VGI circuits and techniques can reduce the number of physical pins and connections used to connect an Application Processor 702 with a peripheral device 724, which may be one of a number (N) of peripheral devices. Signaling state of a plurality of physical GPIO signals can be virtualized as virtual GPIO state that can be transmitted over a communication link 722. In one example, virtual GPIO state may be encoded in packets that are transmitted over a communication link 722 that includes a multi-wire serial bus. The receiving peripheral device 724 may deserialize received packets and extract messages and virtual GPIO state from the deserialized packets. A VGI FSM 726 in the peripheral device 724 may convert the virtual GPIO state to current state of physical GPIO pins or events that can be presented at an internal, physical GPIO interface.

In another example, the communication link 722 may be a provided by a radio frequency transceiver that supports wireless communication using, for example, a Bluetooth protocol, a wireless local area network (WLAN) protocol, a cellular wide area network, and/or another wireless communication protocol. When the communication link 722 includes a wireless connection, messages and virtual GPIO state may be encoded in packets, frames, subframes, or other structures that can be transmitted over the communication link 722, and the receiving peripheral device 724 may extract, deserialize and otherwise process received signaling to obtain the messages and virtual GPIO state. Upon receipt of messages and/or virtual GPIO state, the VGI FSM 726 or another component of the receiving device may interrupt its host processor to indicate receipt of messages and/or any changes in physical GPIO state.

In an example in which the communication link 722 is provided as a serial bus, messages and/or virtual GPIO signals may be transmitted in packets configured for an I2C, I3C, RFFE, SPMI or another standardized serial interface. In the illustrated example, VGI techniques are employed to accommodate I/O bridging between an Application Processor 702 and a peripheral device 724. The Application Processor 702 may be implemented as an ASIC, SoC or some combination of devices. The Application Processor 702 includes a processor (central processing unit or CPU 704) that generates messages and GPIO associated with one or more communications channels 706. Signaling state of GPIO pins, events, and messages produced by the communications channels 706 may be monitored by respective GPIO monitoring circuits 712, 714 in a VGI FSM 726. In some examples, a GPIO monitoring circuit 712 may be adapted to produce virtual GPIO state representative of the state of physical GPIO pins and/or changes in the state of the physical GPIO pins. In some examples, other circuits are provided to produce the virtual GPIO state representative of the signaling state of physical GPIO pins, changes in the signaling state of the physical GPIO pins, and/or an event detected by, or produced within the Application Processor 702.

An estimation circuit 718 may be configured to estimate latency information for communicating GPIO state and/or other information. The estimation circuit 718 may select a protocol, and/or a mode of communication for the communication link 722 that optimizes the latency for encoding and transmitting virtualized GPIO state and/or other information. The estimation circuit 718 may maintain protocol and mode information 716 that characterizes certain aspects of the communication link 722 to be considered when selecting the protocol, and/or a mode of communication. The estimation circuit 718 may be further configured to select a packet type for encoding and transmitting the virtualized GPIO state and/or other information. The estimation circuit 718 may provide configuration information used by a packetizer 720 to encode the virtualized GPIO state and/or other information. In one example, the configuration information is provided as a command that may be encapsulated in a packet such that the type of packet can be determined at a receiver. The configuration information, which may be a command, may also be provided to physical layer circuits (PHY 708). The PHY 708 may use the configuration information to select a protocol and/or mode of communication for transmitting the associated packet. The PHY 708 may then generate the appropriate signaling to transmit the packet.

The peripheral device 724 may include a VGI FSM 726 that can be configured to process data packets received from the communication link 722. The VGI FSM 726 at the peripheral device 724 may extract messages and may map bit positions in virtual GPIO state information onto physical GPIO pins in the peripheral device 724. In certain embodiments, the communication link 722 is bidirectional, and both the Application Processor 702 and a peripheral device 724 may operate as both transmitter and receiver.

The PHY 708 in the Application Processor 702 and a corresponding PHY 728 in the peripheral device 724 may be configured to establish and operate the communication link 722. The PHY 708 and 728 may be coupled to, or include a radio frequency (RF) transceiver 108 (see FIG. 1) that supports RF communications. In some examples, the PHY 708 and 728 may support a two-wire interface such an I2C, I3C, RFFE, SPMI or SMBus interface at the Application Processor 702 and peripheral device 724, respectively and virtual GPIO and messages may be encapsulated into a packet transmitted over the communication link 722, which may be a multi-wire serial bus or multi-wire parallel bus for example.

VGI tunneling, as described herein, can be implemented using existing or available protocols configured for operating the communication link 722, and without the full complement of physical GPIO pins. VGI FSMs 710, 726 may handle VGI signaling without intervention of a processor in the Application Processor 702 and/or in the peripheral device 724. The use of VGI can reduce pin count, power consumption, and latency associated with the communication link 722.

At the receiving device virtual GPIO state is converted into physical GPIO state. Certain characteristics of the physical GPIO pins may be configured using virtual GPIO state. For example, slew rate, polarity, drive strength, and other related parameters and attributes of the physical GPIO pins may be configured using the virtual GPIO state. Configuration parameters used to configure the physical GPIO pins may be stored in configuration registers associated with corresponding GPIO pins. These configuration parameters can be addressed using a proprietary or conventional protocol such as I2C, I3C or RFFE. In one example, configuration parameters may be maintained in I3C addressable registers. Certain aspects disclosed herein relate to reducing latencies associated with the transmission of configuration parameters and corresponding addresses (e.g., addresses of registers used to store configuration parameters).

The VGI interface, or VGI messaging interface (VGMI), enables transmission of messages and virtual GPIO state information, whereby virtual GPIO state, control messages and/or other information can be sent individually or in combination in the serial data stream over a communication link 722. In one example, a serial data stream may be transmitted in packets and/or as a sequence of transactions over an I2C, I3C, SPMI or RFFE bus. The presence of virtual GPIO data in I2C/I3C frame may be signaled using a special command code to identify the frame as a VGPIO frame. VGPIO frames may be transmitted as broadcast frames or addressed frames in accordance with an I2C, I3C, SPMI, RFFE or other protocol. In some implementations, a serial data stream may be transmitted in a form that resembles one or more universal asynchronous receiver/transmitter (UART) signaling and messaging protocols, in what may be referred to as UART_VGI mode of operation.

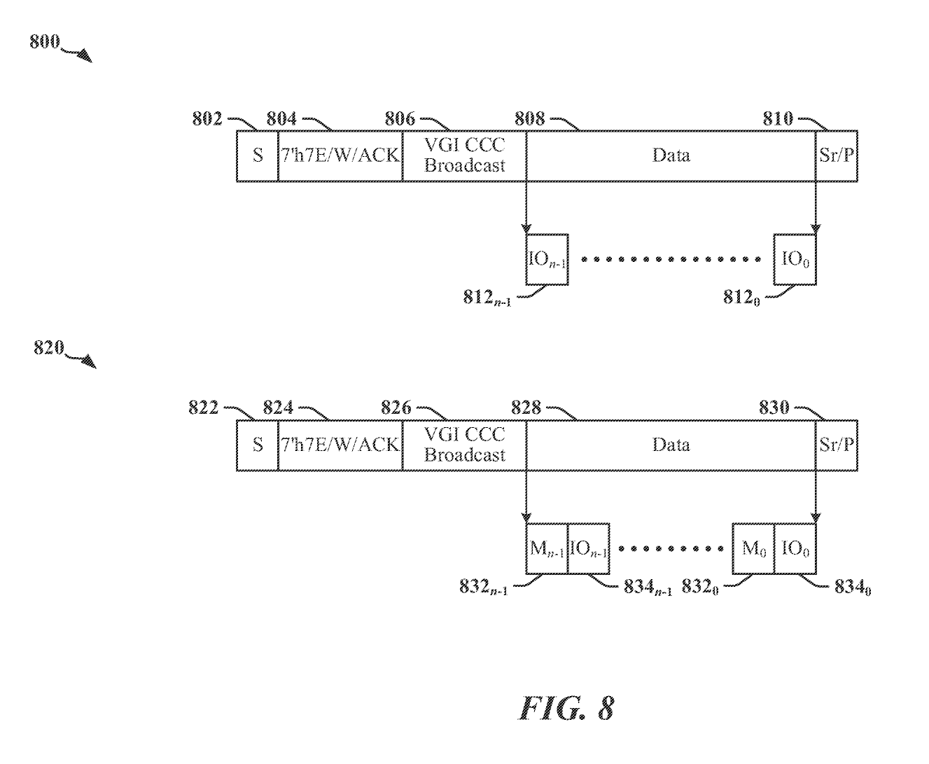

FIG. 8 illustrates examples of VGI broadcast frames 800, 820. In a first example, a VGI broadcast frame 800 commences with a start bit 802 (S) followed by a header 804 in accordance with an I2C or I3C protocol. A VGI broadcast frame may be identified using a VGI broadcast common command code 806. A VGPIO data payload 808 includes a number (n) of virtual GPIO signals 812₀-812ₙ₋₁, ranging from a first virtual GPIO signal 812₀ to an nth virtual GPIO signal 812ₙ₋₁ and representing signaling state of corresponding physical GPIO pins. A VGI FSM may include a mapping table that maps bit positions corresponding to the virtual GPIO signals 812₀-812ₙ₋₁ in a VGPIO data payload 808 to physical GPIO pins. The virtual nature of the signaling in the VGPIO data payload 808 can be transparent to processors in the transmitting and receiving devices.

In the second example, a masked VGI broadcast frame 820 may be transmitted by a host device to change the state of one or more GPIO pins without disturbing the state of other GPIO pins. In this example, the I/O signals for one or more devices are masked, while the I/O signals in a targeted device are unmasked. The masked VGI broadcast frame 820 commences with a start bit 822 followed by a header 824. A masked VGI broadcast frame 820 may be identified using a masked VGI broadcast common command code 826. The VGPIO data payload 828 may include I/O signal values 834₀-834ₙ₋₁ and corresponding mask bits 832₀-832ₙ₋₁, ranging from a first mask bit M₀ 832₀ for the first I/O signal (IO₀) to an nth mask bit Mₙ₋₁ 832ₙ₋₁ for the nth I/O signal IOₙ₋₁.

A stop bit or synchronization bit (Sr/P 810, 830) terminates the VGI broadcast frame 800, 820. A synchronization bit may be transmitted to indicate that an additional VGPIO payload is to be transmitted. In one example, the synchronization bit may be a repeated start bit in an I2C interface.

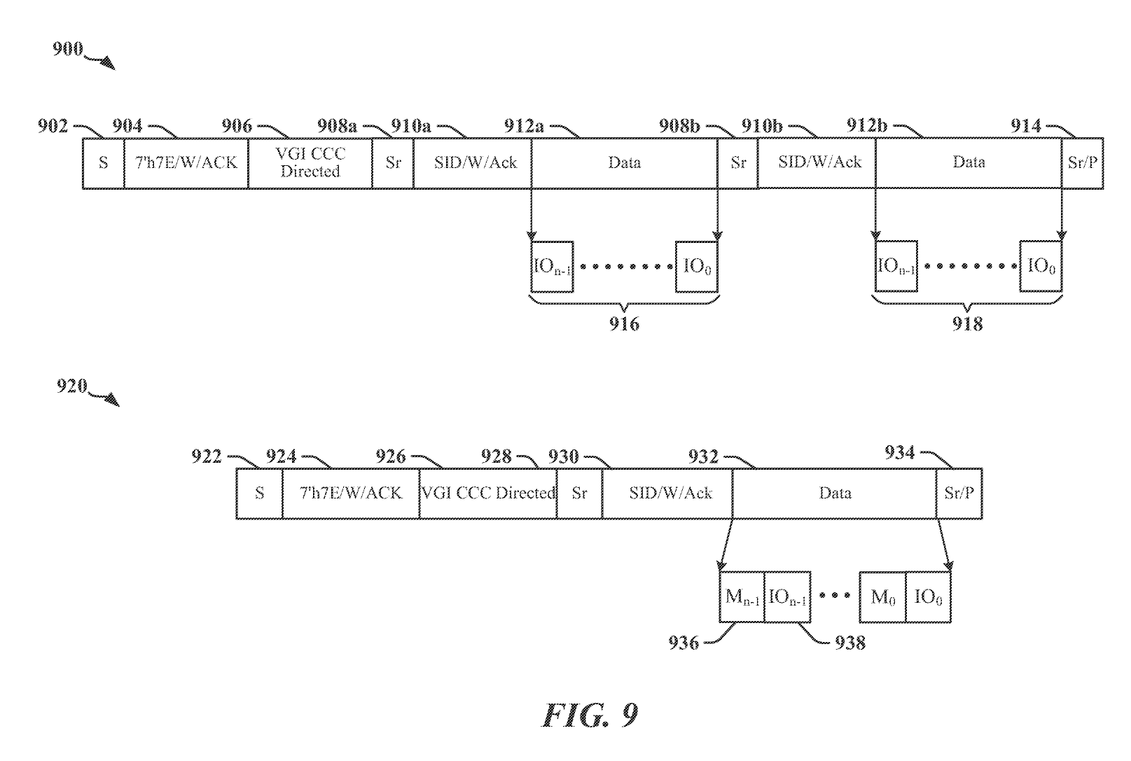

FIG. 9 illustrates examples of VGI directed frames 900, 920. In a first example, VGI directed frames 900 may be addressed to a single peripheral device or, in some instances, to a group of peripheral devices. The first of the VGI directed frames 900 commences with a start bit 902 (S) followed by a header 904 in accordance with an I2C or I3C protocol. A VGI directed frame 900 may be identified using a VGI directed common command code 906. The directed common command code 906 may be followed by a synchronization field 908a (Sr) and an address field 910a that includes a slave identifier to select the addressed device. The directed VGPIO data payload 912a that follows the address field 910a includes values 916 for a set of I/O signals that pertain to the addressed device. VGI directed frames 900 can include additional directed payloads 912b for additional devices. For example, the first directed VGPIO data payload 912a may be followed by a synchronization field 908b and a second address field 910b. In this example, the second directed VGPIO payload 912b includes values 918 for a set of I/O signals that pertain to a second addressed device. The use of VGI directed frames 900 may permit transmission of values for a subset or portion of the I/O signals carried in a VGI broadcast frame 800, 820.

In the second example, a masked VGI directed frame 920 may be transmitted by a host device to change the state of one or more GPIO pins without disturbing the state of other GPIO pins in a single peripheral device and without affecting other peripheral devices. In some examples, the I/O signals in one or more devices may be masked, while selected I/O signals in one or more targeted device are unmasked. The masked VGI directed frame 920 commences with a start bit 922 followed by a header 924. A masked VGI directed frame 920 may be identified using a masked VGI directed common command code 926. The masked VGI directed command code 926 may be followed by a synchronization field 928 (Sr) and an address field 930 that includes a slave identifier to select the addressed device. The directed payload 932 that follows includes VGPIO values for a set of I/O signals that pertain to the addressed device. For example, the VGPIO values in the directed data payload 932 may include I/O signal values 938 and corresponding mask bits 936.

A stop bit or synchronization bit (Sr/P 914, 934) terminates the VGI directed frames 900, 920. A synchronization bit may be transmitted to indicate that an additional VGPIO payload is to be transmitted. In one example, the synchronization bit may be a repeated start bit in an I2C interface.

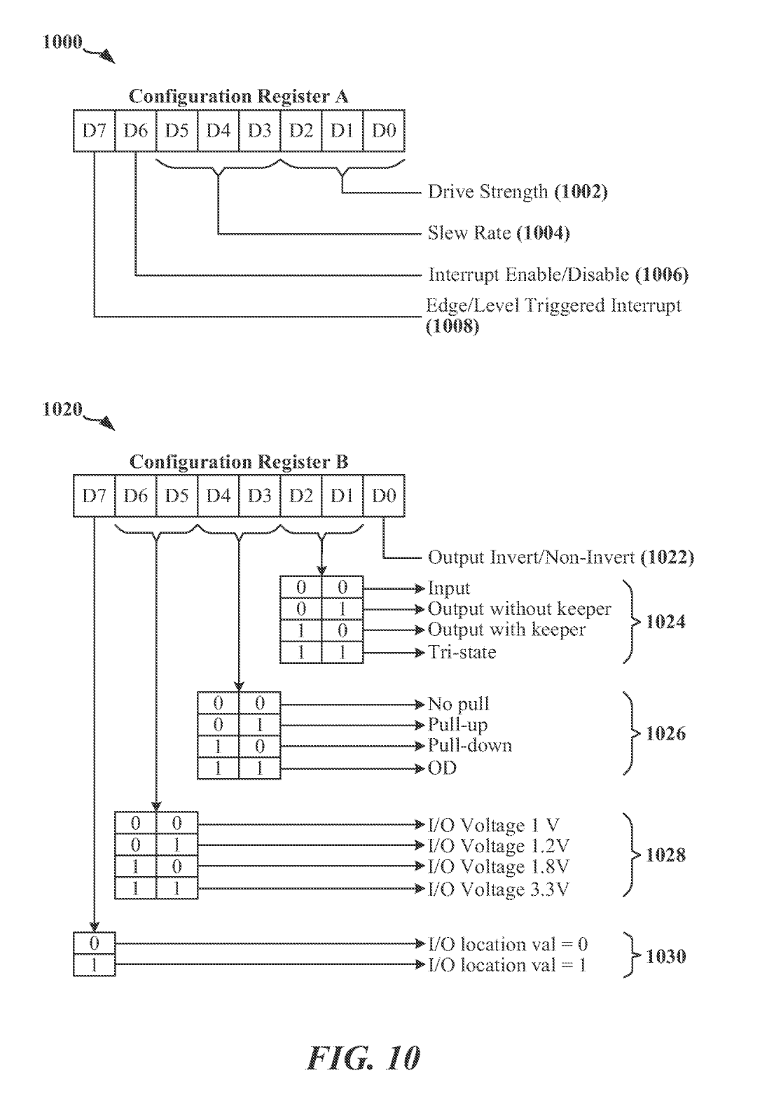

At the receiving device (e.g., the Application Processor 602 and/or peripheral device 604, 606, 608), received virtual GPIO signals are expanded into physical GPIO signaling states presented on GPIO pins. The term “pin,” as used herein, may refer to a physical structure such as a pad, pin or other interconnecting element used to couple an IC to a wire, trace, through-hole via, or other suitable physical connector provided on a circuit board, substrate or the like. Each GPIO pin may be associated with one or more configuration registers that store configuration parameters for the GPIO pin. FIG. 10 illustrates configuration registers 1000 and 1020 that may be associated with a physical pin. Each configuration register 1000, 1020 is implemented as a one-byte (8 bits) register, where different bits or groups of bits define a characteristic or other feature that can be controlled through configuration. In a first example, bits D0-D2 1002 control the drive strength for the GPIO pin, bits D3-D5 1004 control the slew rate for GPIO pin, bit D6 1006 enables interrupts, and bit D7 1008 determines whether interrupts are edge-triggered or triggered by voltage-level. In a second example, bit D0 1022 selects whether the GPIO pin receives an inverted or non-inverted signal, bits D1-D2 1024 define a type of input or output pin, bits D3-D4 1026 defines certain characteristics of an undriven pin, bits D5-D6 1028 define voltage levels for signaling states, and bit D7 1030 controls the binary value for the GPIO pin (i.e., whether GPIO pin carries carry a binary one or zero).

Mixed GPIO State Exchange

In conventional interfaces that employ VGPIO to exchange GPIO state information, a transmitting device can send VGPIO state values that are that represent only the states of output physical GPIO pins. A receiving device can unambiguously receive the VGPIO state values. According to certain aspects of this disclosure, VGI integration may be supported when mixed VGPIO state information is communicated as 1-byte values or multi-byte values that can include values for both input and output VGPIO bits. Mixed VGPIO state information may be communicated over a communication bus that is operated in accordance with an I2C, I3C, SPMI or RFFE protocol. VGPIO state information may be mixed in order to reduce complexity of hardware architecture.

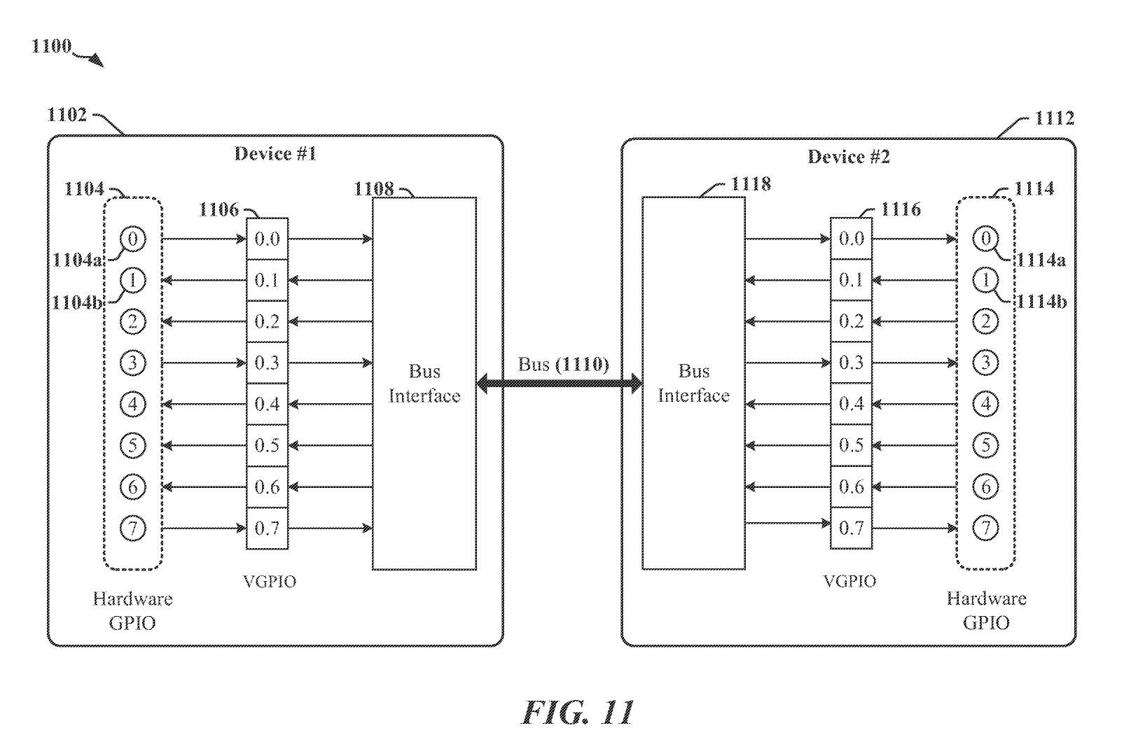

FIG. 11 illustrates a system 1100 that may be adapted to support the exchange of mixed VGPIO state information. In this system, a 1-byte VGPIO state register 1106, 1116 maintains state information that includes values for input VGPIO bits and output VGPIO bits. For example, a first device 1102 maintains a VGPIO state register 1106 corresponding to a set of GPIO pins 1104. The VGPIO state register 1106 includes information representing an output pin 1104a and an input pin 1104b. A second device 1112 exchanges VGPIO information with the first device 1102 through a bus 1110, and the second device 1112 maintains a VGPIO state register 1116 corresponding to a set of GPIO pins 1114. The VGPIO state register 1116 includes information representing an input pin 1114a and an output pin 1114b. The state information for the output pin 1104a of the first device 1102 is received by the second device 1112 as state information for the input pin 1114a. The state information for the input pin 1104b of the first device 1102 is intended to maintain state information transmitted by the second device 1112 representing the state of the output pin 1114b in the second device 1112. Certain values of the VGPIO state register 1106 transmitted through the bus interface 1108 of the first device may cause the bus interface 1118 of the second device 1112 to overwrite output state information in the VGPIO state register 1116 representing output pins in the set of GPIO pins 1114, including the output pin 1114b for example. The arrival at the second device 1112 of a byte of VGPIO information containing both input and output VGPIO bits can corrupt the output VGPIO bits in the VGPIO state register 1116 maintained by the second device 1112.

When the first device 1102 is permitted to transmit mixed VGPIO bits that can change corresponding locations in the VGPIO state register 1116 of the second device 1112, the mixed VGPIO bits may corrupt the values of the output locations in the VGPIO state register 1116 of the second device 1112, if the corresponding bits in the VGPIO state register 1106 of the first device 1102 (previously received as inputs) are different.

In some implementations, the first device 1102 may transmit a mask byte with the VGPIO state register 1106 to enable the second device 1112 to block bits related to output VGPIO bits of the VGPIO state register 1116 in the second device 1112. Transmission of a mask byte increases transmission latency and may be undesirable or inappropriate for certain applications.

According to certain aspects of this disclosure, a configurable masking capability is provided in devices that communicate VGPIO state information in mixed bytes. An overwrite prevention technique may be employed using a certain register configuration to automatically decode direction associated with VGPIO bits at a receiving device and avoid output VGPIO state corruption at the receiving device.

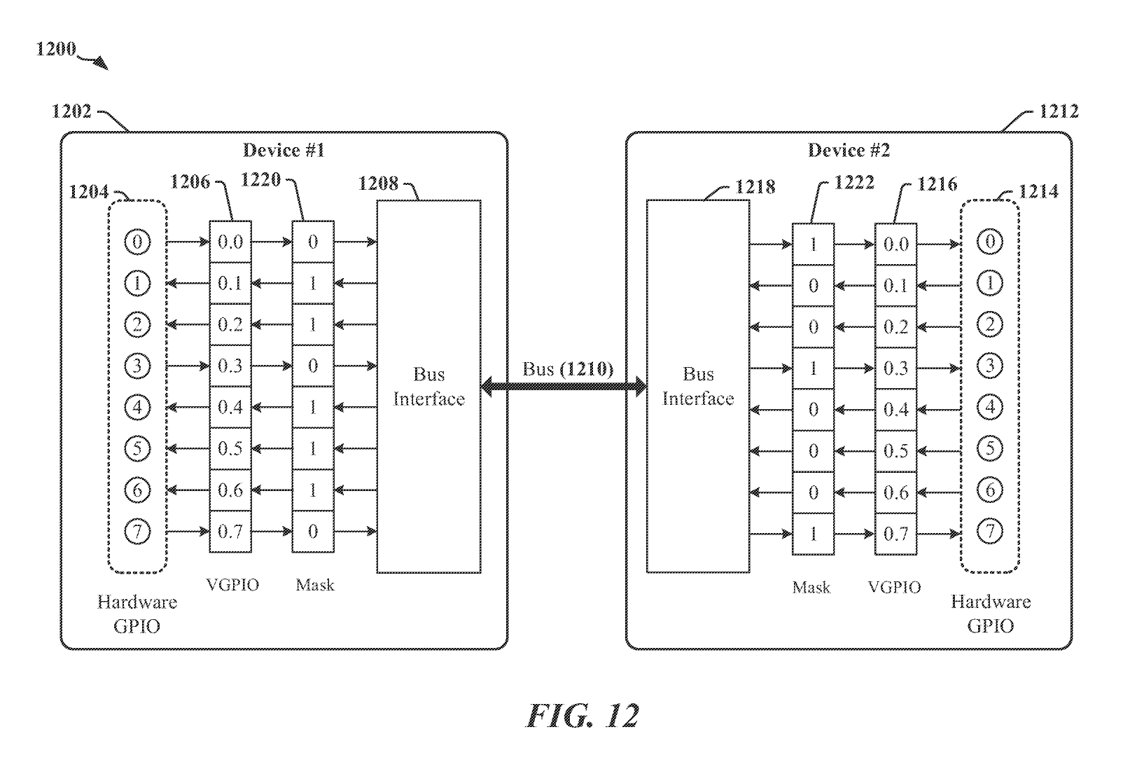

FIG. 12 illustrates a system 1200 adapted to avoid output VGPIO state corruption at the receiving device in accordance with certain aspects disclosed herein. FIG. 12 illustrates the receive path in a first device 1202 and in the second device 1212. That is, the path between VGPIO state registers 1206, 1216 and the bus interfaces 1208 and 1218 may be different for transmission of VGPIO state information. In the illustrated example, a 1-byte VGPIO state register 1206, 1216 maintains state information that includes values for input VGPIO bits and output VGPIO bits. For example, a first device 1202 maintains a VGPIO state register 1206 corresponding to a set of GPIO pins 1204. The VGPIO state register 1206 includes information representing output pins and input pins. A second device 1212 exchanges VGPIO information with the first device 1202 through a bus 1210, and the second device 1212 maintains a VGPIO state register 1216 corresponding to a set of GPIO pins 1214. The VGPIO state register 1216 includes information representing input pins and output pins. The state information for the output pins of the first device 1202 is received by the second device 1212 as state information for corresponding input pins.

The arrival at the first device 1202 of a byte of VGPIO information containing both input and output VGPIO bits is automatically masked using a mask register 1220 to prevent corruption of output VGPIO bits in the VGPIO state register 1206 maintained by the first device 1202. The arrival at the second device 1212 of a byte of VGPIO information containing both input and output VGPIO bits is automatically masked using a mask register 1222 to prevent corruption of output VGPIO bits in the VGPIO state register 1216 maintained by the second device 1212.

The mask registers 1220, 1222 may operate to prevent individual bits received from the respective interfaces 1208, 1218 from being loaded into corresponding bits of the respective VGPIO state registers 1206, 1216. In the illustrated example, a bit value of ‘0’ in a mask register 1220, 1222 blocks loading of an arriving bit into the respective VGPIO state register 1206, 1216. In another example, a bit value of ‘1’ in a mask register 1220, 1222 may block loading of an arriving bit into the respective VGPIO state register 1206, 1216. The mask registers 1220, 1222 provide local output overwrite protection. The mask registers 1220, 1222 may be statically configured in accordance with system input/output design. Static configuration may be performed during manufacturing or at system initialization. In some instances, the mask registers 1220, 1222 may be dynamically configured. When the bus 1210 is configured for point-to-point communication, the mask register 1220 in the first device 1202 may be configured with a value that is the logical inversion of the value used to configure the mask register 1222 in the second device 1212.

VGPIO information arriving at the bus interfaces 1208, 1218 and directed to respective VGPIO state registers 1206, 1216 may be masked based on bit settings of the respective mask registers 1220, 1222. Masking logic may control a masking process. In one example, the bits of a mask register 1220, 1222 may be used to gate, on an individual basis, signals that cause the VGPIO state registers 1206, 1216 to capture bits received through the bus interface 1208, 1218. In another example, the bits of a mask register 1220, 1222 may be used control a multiplexer such that the multiplexer selects a current bit value of the VGPIO state register 1206, 1216 to be written to the VGPIO state register 1206, 1216 when the bit is masked, and to select a received bit value to be written to the VGPIO state register 1206, 1216 when the bit is not masked.

Examples of Processing Circuits and Methods

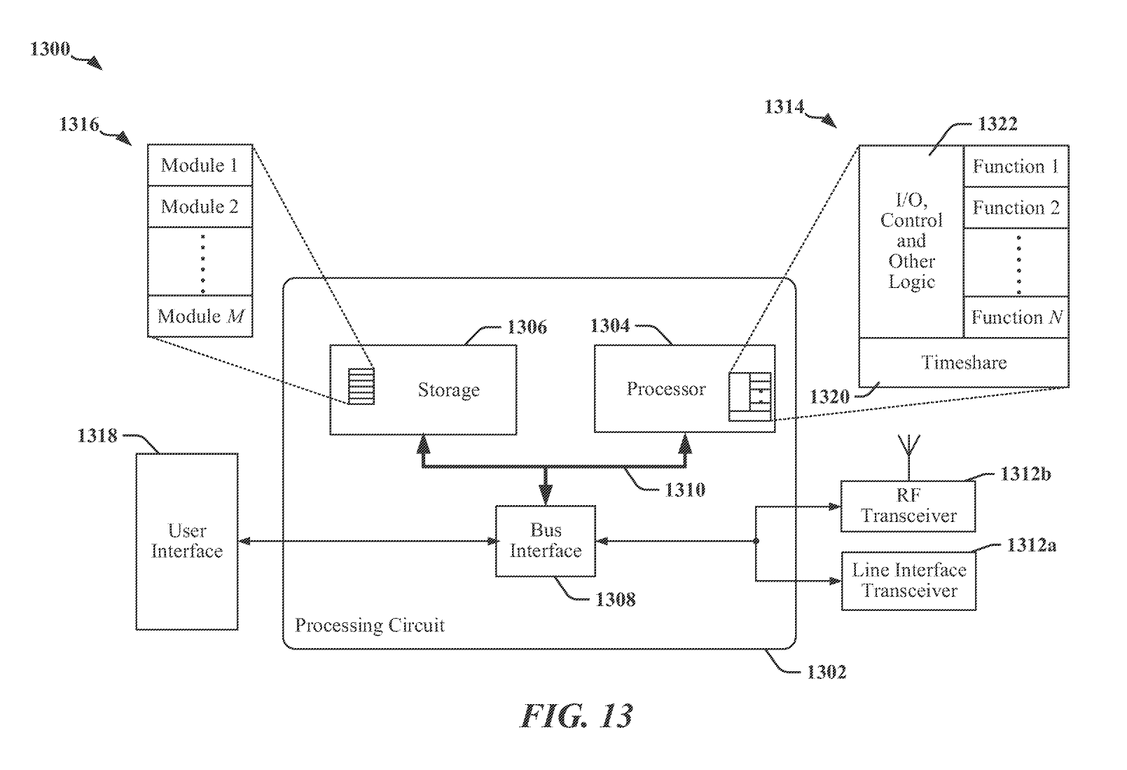

FIG. 13 is a diagram illustrating an example of a hardware implementation for an apparatus 1300. In some examples, the apparatus 1300 may configure and operate a finite state machine (see the VGI FSMs 710, 726 of FIG. 7) to optimize virtual GPIO latency. The apparatus 1300 may perform one or more functions disclosed herein. In accordance with various aspects of the disclosure, an element, or any portion of an element, or any combination of elements as disclosed herein may be implemented using a processing circuit 1302. The processing circuit 1302 may include one or more processors 1304 that are controlled by some combination of hardware and software modules. Examples of processors 1304 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1304 may include specialized processors that perform specific functions, and that may be configured, augmented or controlled by one of the software modules 1316. The one or more processors 1304 may be configured through a combination of software modules 1316 loaded during initialization, and further configured by loading or unloading one or more software modules 1316 during operation.

In the illustrated example, the processing circuit 1302 may be implemented with a bus architecture, represented generally by the bus 1310. The bus 1310 may include any number of interconnecting buses and bridges depending on the specific application of the processing circuit 1302 and the overall design constraints. The bus 1310 links together various circuits including the one or more processors 1304, and storage 1306. Storage 1306 may include memory devices and mass storage devices and may be referred to herein as computer-readable media and/or processor-readable media. The bus 1310 may also link various other circuits such as timing sources, timers, peripherals, voltage regulators, and power management circuits. A bus interface 1308 may provide an interface between the bus 1310 and one or more transceivers 1312a, 1312b. A transceiver 1312a, 1312b may be provided for each networking technology supported by the processing circuit. In some instances, multiple networking technologies may share some or all of the circuitry or processing modules found in a transceiver 1312a, 1312b. Each transceiver 1312a, 1312b provides a means for communicating with various other apparatus over a transmission medium. In one example, a transceiver 1312a may be used to couple the apparatus 1300 to a multi-wire bus. In another example, a transceiver 1312b may be used to connect the apparatus 1300 to a wireless network. Depending upon the nature of the apparatus 1300, a user interface 1318 (e.g., keypad, display, speaker, microphone, joystick) may also be provided, and may be communicatively coupled to the bus 1310 directly or through the bus interface 1308.

A processor 1304 may be responsible for managing the bus 1310 and for general processing that may include the execution of software stored in a computer-readable medium that may include the storage 1306. In this respect, the processing circuit 1302, including the processor 1304, may be used to implement any of the methods, functions and techniques disclosed herein. The storage 1306 may be used for storing data that is manipulated by the processor 1304 when executing software, and the software may be configured to implement any one of the methods disclosed herein.

One or more processors 1304 in the processing circuit 1302 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1306 or in an external computer-readable medium. The external computer-readable medium and/or storage 1306 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1306 may also include, by way of example, a carrier wave, a transmission line, and any other suitable medium for transmitting software and/or instructions that may be accessed and read by a computer. Computer-readable medium and/or the storage 1306 may reside in the processing circuit 1302, in the processor 1304, external to the processing circuit 1302, or be distributed across multiple entities including the processing circuit 1302. The computer-readable medium and/or storage 1306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1306 may maintain software maintained and/or organized in loadable code segments, modules, applications, programs, etc., which may be referred to herein as software modules 1316. Each of the software modules 1316 may include instructions and data that, when installed or loaded on the processing circuit 1302 and executed by the one or more processors 1304, contribute to a run-time image 1314 that controls the operation of the one or more processors 1304. When executed, certain instructions may cause the processing circuit 1302 to perform functions in accordance with certain methods, algorithms and processes described herein.

Some of the software modules 1316 may be loaded during initialization of the processing circuit 1302, and these software modules 1316 may configure the processing circuit 1302 to enable performance of the various functions disclosed herein. For example, some software modules 1316 may configure internal devices and/or logic circuits 1322 of the processor 1304, and may manage access to external devices such as the transceiver 1312a, 1312b, the bus interface 1308, the user interface 1318, timers, mathematical coprocessors, and so on. The software modules 1316 may include a control program and/or an operating system that interacts with interrupt handlers and device drivers, and that controls access to various resources provided by the processing circuit 1302. The resources may include memory, processing time, access to the transceiver 1312a, 1312b, the user interface 1318, and so on.

One or more processors 1304 of the processing circuit 1302 may be multifunctional, whereby some of the software modules 1316 are loaded and configured to perform different functions or different instances of the same function. The one or more processors 1304 may additionally be adapted to manage background tasks initiated in response to inputs from the user interface 1318, the transceiver 1312a, 1312b, and device drivers, for example. To support the performance of multiple functions, the one or more processors 1304 may be configured to provide a multitasking environment, whereby each of a plurality of functions is implemented as a set of tasks serviced by the one or more processors 1304 as needed or desired. In one example, the multitasking environment may be implemented using a timesharing program 1320 that passes control of a processor 1304 between different tasks, whereby each task returns control of the one or more processors 1304 to the timesharing program 1320 upon completion of any outstanding operations and/or in response to an input such as an interrupt. When a task has control of the one or more processors 1304, the processing circuit is effectively specialized for the purposes addressed by the function associated with the controlling task. The timesharing program 1320 may include an operating system, a main loop that transfers control on a round-robin basis, a function that allocates control of the one or more processors 1304 in accordance with a prioritization of the functions, and/or an interrupt driven main loop that responds to external events by providing control of the one or more processors 1304 to a handling function.

Methods for optimizing virtual GPIO latency may include an act of parsing various input sources including sources of GPIO signal state, parameters and/or messages to be transmitted. The input sources may include hardware events, configuration data, mask parameters, and register addresses. Packet-specific latency estimators may be employed to estimate the latency for corresponding packet types based upon the parsed parameters. A packet type to be used for transmission may be selected based on the minimum latency calculated or determined for available packet types. The selected packet type may be identified using a command code, which may be provided to a packetizer with a payload to be transmitted. The command code may also reflect a protocol to be used to transmit the payload. In some implementations, the physical link used to transmit the payload may be operated according to different protocols or different variants of one or more protocols. The protocol to be used for transmitting the payload may be selected based on latencies associated with the various available protocols or variants of protocols.

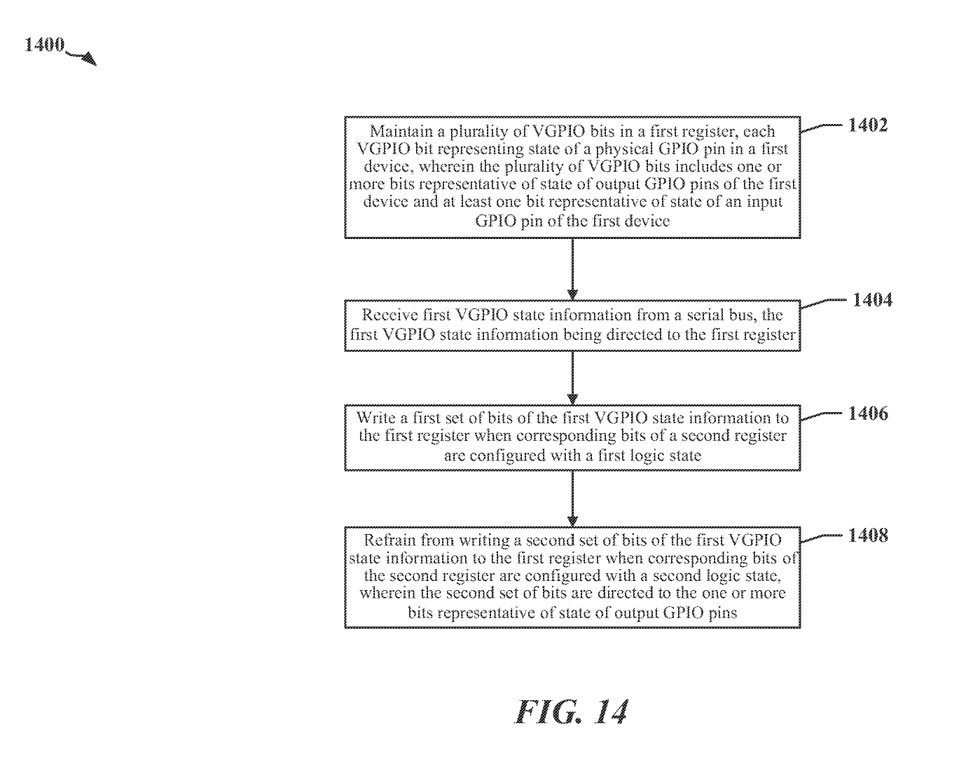

FIG. 14 is a flowchart 1400 of a method that may be performed at a device coupled to a serial bus. Certain circuits involved in executing the method may be configured by a finite state machine. Additionally, or alternatively, a finite state machine may perform certain portions of the method.

As represented by block 1402, the device may maintain a plurality of VGPIO bits in a first register. Each VGPIO bit may represent state of a physical GPIO terminal pin in a first device. The plurality of VGPIO bits may include one or more bits representative of state of output GPIO pins of the first device. The plurality of VGPIO bits may include at least one bit representative of state of an input GPIO pin of the first device.

As represented by block 1404, the device may receive first VGPIO state information from a serial bus. The first VGPIO state information may be directed to the first register.

As represented by block 1406, the device may write a first set of bits of the first VGPIO state information to the first register when corresponding bits of a second register are configured with a first logic state.

As represented by block 1408, the device may refrain from writing a second set of bits of the first VGPIO state information to the first register when corresponding bits of the second register are configured with a second logic state. The second set of bits is directed to the one or more bits representative of state of output GPIO pins.

In some examples, the device may configure the second register with a first masking value that corresponds to a configuration of input GPIO pins and output GPIO pins for which state is represented by the first register. The second register may be configured during initialization of the first device.

In various examples, the first VGPIO state information is received from a second device. The second device may include a third register configured with a plurality of mask bits, each mask bit corresponding to a GPIO pin of the second device. The third register may be configured with a mask value operable to prevent bits of second VGPIO state information from being written to a VGPIO register of the second device that maintains state of output GPIO pins of the second device. The device may transmit the second VGPIO state information from the first device over the serial bus to the second device. The second VGPIO state information may include at least a portion of the content of the first register. The third register may be configured with a value that is a logical inversion of a value used to configure the second register. The serial bus may be operated in accordance with an I3C, SPMI, or RFFE protocol.

According to some aspects disclosed herein, the device may include a finite state machine adapted to manage generation of VGPIO state information and/or to support or manage translations between physical GPIO state and VGPIO state information. For example, the finite state machine may detect changes in physical GPIO state measurable or observable at one or more GPIO pin. The finite state machine may initiate a transmission of virtual GPIO state in response to detection of changes in physical GPIO state. In some instances, the finite state machine may be configured to periodically initiate transmissions of current physical GPIO state. In one example, physical GPIO state may be represented by one or more bit values obtained by capturing the binary state on a GPIO pin. In another example, physical GPIO state may be represented by one or more bit values stored in a register or other logic that can drive the physical GPIO state. In at least some instances, a physical GPIO pin may not be assigned for bits of the latter register. In another example, software events may be represented in one or more bits that mimic physical GPIO without a physical GPIO pin being provided in the device.

The finite state machine and/or associated logic and circuits may operate to characterize the physical state information as virtual state information. The finite state machine may transmit the virtual state information over the serial bus.

In some examples, the finite state machine may receive input VGPIO state information directed to the at least one bit representative of state of an input GPIO pin. The finite state machine and/or associated logic and circuits may be operated to physically drive the input GPIO pin in accordance with the input VGPIO state information.

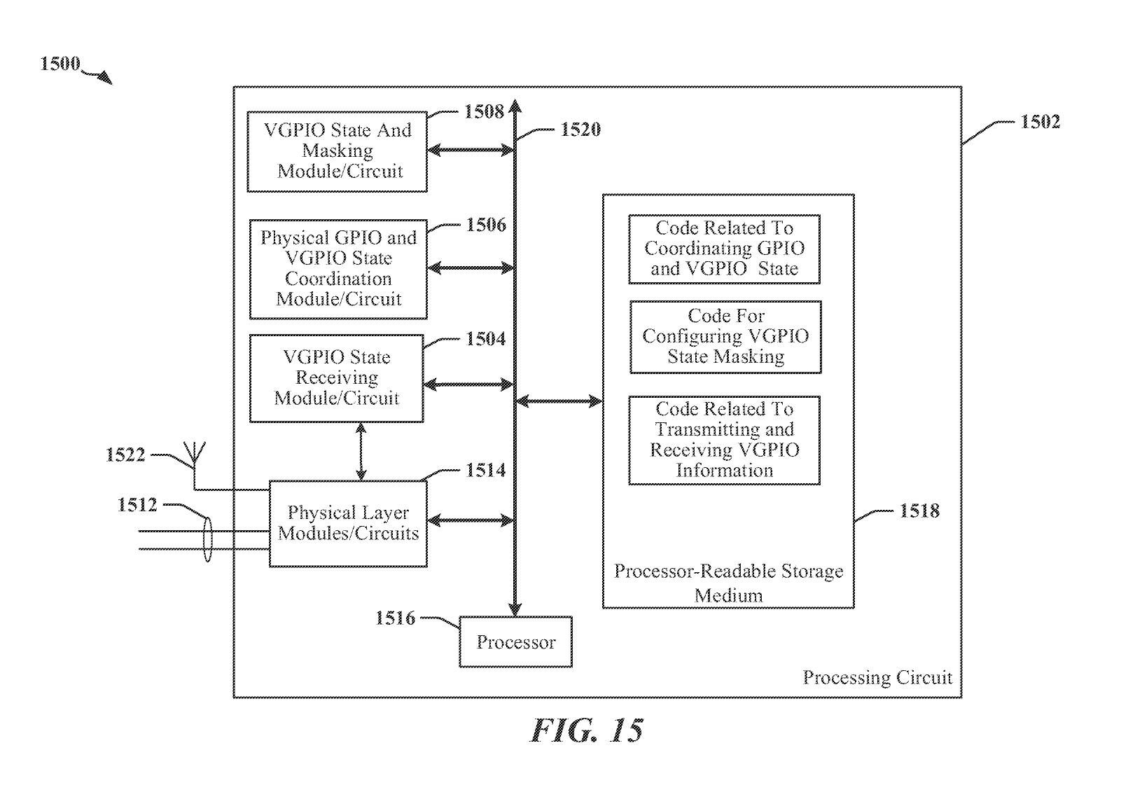

FIG. 15 is a diagram illustrating a simplified example of a hardware implementation for an apparatus 1500 employing a processing circuit 1502. The apparatus may implement a bridging circuit in accordance with certain aspects disclosed herein. The processing circuit typically has a controller or processor 1516 that may include one or more microprocessors, microcontrollers, digital signal processors, sequencers and/or state machines. The processing circuit 1502 may be implemented with a bus architecture, represented generally by the bus 1520. The bus 1520 may include any number of interconnecting buses and bridges depending on the specific application of the processing circuit 1502 and the overall design constraints. The bus 1520 links together various circuits including one or more processors and/or hardware modules, represented by the controller or processor 1516, the modules or circuits 1504, 1506 and 1508, and the processor-readable storage medium 1518. One or more physical layer circuits and/or modules 1514 may be provided to support communications over a communication link implemented using a multi-wire bus 1512, through an antenna 1522 (to a wireless network for example), and so on. The bus 1520 may also link various other circuits such as timing sources, peripherals, voltage regulators, and power management circuits, which are well known in the art, and therefore, will not be described any further.

The processor 1516 is responsible for general processing, including the execution of software, code and/or instructions stored on the processor-readable storage medium 1518. The processor-readable storage medium may include a non-transitory storage medium. The software, when executed by the processor 1516, causes the processing circuit 1502 to perform the various functions described supra for any particular apparatus. The processor-readable storage medium may be used for storing data that is manipulated by the processor 1516 when executing software. The processing circuit 1502 further includes at least one of the modules 1504, 1506 and 1508. The modules 1504, 1506 and 1508 may be software modules running in the processor 1516, resident/stored in the processor-readable storage medium 1518, one or more hardware modules coupled to the processor 1516, or some combination thereof. The modules 1504, 1506 and 1508 may include microcontroller instructions, state machine configuration parameters, or some combination thereof.

In one configuration, the apparatus 1500 includes modules and/or circuits 1506, 1508 configured to operate a plurality of registers. A first register may be adapted to maintain a plurality of VGPIO bits, each VGPIO bit representing state of a physical general-purpose input/output (GPIO) pin. The plurality of VGPIO bits may include one or more bits representative of state of output GPIO pins of the apparatus and at least one bit representative of state of an input GPIO pin of the apparatus. A second register may be configured with a plurality of mask bits, each mask bit corresponding to one of the plurality of VGPIO bits. The apparatus 1500 may include modules and/or circuits 1504, 1514 configured to receive VGPIO state information from a multi-wire bus 1512, which may be a serial bus. In certain examples, the serial bus is operated in accordance with an I3C, SPMI, or RFFE protocol. The VGPIO state information may be directed to the first register. The modules and/or circuits 1508 may include a masking circuit adapted to prevent bits of the VGPIO state information directed to the one or more bits representative of the state of output GPIO pins from being written to the first register.

In one example, each bit of the second register configured to have a first logic state (i.e., 1 or 0) enables a corresponding bit of the VGPIO state information to be written to the first register. Each bit of the second register that is configured to have a second logic state (i.e., 0 or 1) prevents a corresponding bit of the VGPIO state information to be written to the first register. In some instances, the second register is configured during initialization of the apparatus.

In various examples, the VGPIO state information is received from an integrated circuit device coupled to the serial bus. The VGPIO state information may represent state of output GPIO pins of the integrated circuit device. The integrated circuit device may have a third register configured with a plurality of mask bits, each mask bit corresponding to one of the output GPIO pins of the integrated circuit device or an input GPIO pin of the integrated circuit device. Bit-settings of the third register may operate to prevent VGPIO bits transmitted by the apparatus from modifying bits of VGPIO state information representative of the state of output GPIO pins of the integrated circuit device. The third register may be configured with a value that is a logical inversion of a value used to configure the second register.

In another configuration, the apparatus 1500 includes two or more IC devices and a multi-wire 1512 which may be a serial bus. The apparatus 1500 may include a plurality of registers. Modules and/or circuits 1506, 1508 may be configured to maintain, in a first register, a first plurality of VGPIO bits, each bit representing state of a physical GPIO terminal in the IC device. The first plurality of VGPIO bits may include one or more bits representative of output GPIO terminals in the IC device and at least one bit representative of an GPIO terminal in the first IC device. The modules and/or circuits 1506, 1508 may be configured to configure a second register with a plurality of mask bits, each mask bit corresponding to one of the first plurality of VGPIO bits.

The apparatus 1500 may include a bus interface 1514 in each IC device configured to receive VGPIO state information directed to the first register from the multi-wire bus 1512, The VGPIO state information may include a second plurality of VGPIO bits that has one or more bits representative of output GPIO terminals in a different IC device.

The apparatus 1500 may include a masking circuit in each IC device adapted to prevent the one or more bits representative of the output GPIO terminals in the IC device from being overwritten by the second plurality of VGPIO bits.

In one example, the two IC devices are configured to transmit content of their respective first registers in VGPIO state information transmitted over the serial bus.

In one example, the second registers of the two IC devices are configured with two different values that are logical inversions of each other.

In certain examples, the output GPIO terminals in a first IC device correspond to the input GPIO terminals in a second IC device. The input GPIO terminals in the first IC device may correspond to the output GPIO terminals in the second IC device.

The apparatus 1500 may include a finite state machine in addition to, or to serve as the processor 1516. The finite state machine may be adapted to manage generation of VGPIO state information and/or to support or manage translations between physical GPIO state and VGPIO state information. For example, the finite state machine may detect changes in physical GPIO state measurable or observable at one or more GPIO pin. The finite state machine may initiate a transmission of virtual GPIO state in response to detection of changes in physical GPIO state. In some instances, the finite state machine may be configured to periodically initiate transmissions of current physical GPIO state. In one example, physical GPIO state may be represented by one or more bit values obtained by capturing the binary state on a GPIO pin. In another example, physical GPIO state may be represented by one or more bit values stored in a register or other logic that can drive the physical GPIO state. In at least some instances, a physical GPIO pin may not be assigned for bits of the latter register. In another example, software events may be represented in one or more bits that mimic physical GPIO without a physical GPIO pin being provided in the device.

The finite state machine and/or associated logic and circuits may operate to characterize the physical state information as virtual state information. The finite state machine may transmit the virtual state information over the serial bus.

In some examples, the finite state machine may receive input VGPIO state information directed to the at least one bit representative of state of an input GPIO pin. The finite state machine and/or associated logic and circuits may be operated to physically drive the input GPIO pin in accordance with the input VGPIO state information.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. An apparatus comprising:
a first register adapted to maintain a plurality of virtual general-purpose input/output (VGPIO) bits, each VGPIO bit representing state of a physical general-purpose input/output (GPIO) pin, wherein the plurality of VGPIO bits includes one or more bits representative of state of output GPIO pins of the apparatus and at least one bit representative of state of an input GPIO pin of the apparatus;
a second register configured with a plurality of mask bits, each mask bit corresponding to one of the plurality of VGPIO bits;
a bus interface configured to extract VGPIO state information packets received from a serial bus, the VGPIO state information being directed to the first register; and
a masking circuit adapted to prevent bits of the VGPIO state information directed to the one or more bits representative of the state of output GPIO pins from being written to the first register.

2. The apparatus of claim 1, wherein each bit of the second register that is configured to have a first logic state enables a corresponding bit of the VGPIO state information to be written to the first register, and each bit of the second register that is configured to have a second logic state prevents a corresponding bit of the VGPIO state information to be written to the first register.

3. The apparatus of claim 1, wherein the VGPIO state information is received from an integrated circuit device coupled to the serial bus, and wherein the VGPIO state information represents state of output GPIO pins of the integrated circuit device.

4. The apparatus of claim 3, wherein the integrated circuit device comprises:
a third register configured with a plurality of mask bits, each mask bit corresponding to one of the output GPIO pins of the integrated circuit device or an input GPIO pin of the integrated circuit device,
wherein bit-settings of the third register operate to prevent VGPIO bits transmitted by the apparatus from modifying bits of VGPIO state information representative of the state of output GPIO pins of the integrated circuit device.

5. The apparatus of claim 4, wherein the third register is configured with a value that is a logical inversion of a value used to configure the second register.

6. The apparatus of claim 1, wherein the second register is configured during initialization of the apparatus.

7. The apparatus of claim 1, wherein the serial bus is operated in accordance with an I3C, system power management interface (SPMI), or Radio Frequency Front-End (RFFE) protocol.

8. The apparatus of claim 1, and further comprising a finite state machine adapted to:
detect physical state information of at least one output GPIO pin;
characterize the physical state information as virtual state information; and
cause the virtual state information to be transmitted over the serial bus.

9. The apparatus of claim 1, and further comprising a finite state machine adapted to:
receive input VGPIO state information directed to the at least one bit representative of state of the input GPIO pin; and
drive the input GPIO pin in accordance with the input VGPIO state information.

10. A method comprising:
maintaining a plurality of virtual general-purpose input/output (VGPIO) bits in a first register, each VGPIO bit representing state of a physical general-purpose input/output (GPIO) pin in a first device, wherein the plurality of VGPIO bits includes one or more bits representative of state of output GPIO pins of the first device and at least one bit representative of state of an input GPIO pin of the first device;
receiving first VGPIO state information from a serial bus, the first VGPIO state information being directed to the first register;
writing a first set of bits of the first VGPIO state information to the first register when corresponding bits of a second register are configured with a first logic state; and
refraining from writing a second set of bits of the first VGPIO state information to the first register when corresponding bits of the second register are configured with a second logic state, wherein the second set of bits is directed to the one or more bits representative of state of output GPIO pins.

11. The method of claim 10, and further comprising:
configuring the second register with a first masking value that corresponds to a configuration of input GPIO pins and output GPIO pins for which state is represented by the first register.

12. The method of claim 11, wherein the second register is configured during initialization of the first device.

13. The method of claim 10, wherein the first VGPIO state information is received from a second device, and wherein the second device includes a third register configured with a plurality of mask bits, each mask bit corresponding to a GPIO pin of the second device, and wherein the third register is configured with a mask value operable to prevent bits of second VGPIO state information from being written to a VGPIO register of the second device that maintains state of output GPIO pins of the second device.

14. The method of claim 13, and further comprising:
transmitting the second VGPIO state information from the first device over the serial bus to the second device.

15. The method of claim 13, wherein the second VGPIO state information comprises content of the first register.

16. The method of claim 13, wherein the third register is configured with a value that is a logical inversion of a value used to configure the second register.

17. The method of claim 10, wherein the serial bus is operated in accordance with an I3C, system power management interface (SPMI), or Radio Frequency Front-End (RFFE) protocol.

18. The method of claim 10, and further comprising:
configuring a finite state machine to
detect physical state information of at least one output GPIO pin, and
characterize the physical state information as virtual state information; and
transmitting the virtual state information over the serial bus.

19. The method of claim 10, and further comprising:
receiving input VGPIO state information directed to the at least one bit representative of state of the input GPIO pin; and
driving the input GPIO pin in accordance with the input VGPIO state information.

20. An apparatus comprising:
a serial bus; and
two integrated circuit devices coupled to the serial bus, each integrated circuit device including:
a first register adapted to maintain a first plurality of virtual general-purpose input/output (VGPIO) bits, each bit representing state of a physical general-purpose input/output (GPIO) terminal in the integrated circuit device, wherein the first plurality of VGPIO bits includes one or more bits representative of output GPIO terminals in the integrated circuit device and at least one bit representative of state of a GPIO terminal in the first integrated circuit device;
a second register configured with a plurality of mask bits, each mask bit corresponding to one of the first plurality of VGPIO bits;
a bus interface configured to receive VGPIO state information directed to the first register from the serial bus, the VGPIO state information comprising a second plurality of VGPIO bits that includes one or more bits representative of output GPIO terminals in a different integrated circuit device; and
a masking circuit adapted to prevent the one or more bits representative of the output GPIO terminals in the integrated circuit device from being overwritten by the second plurality of VGPIO bits.

21. The apparatus of claim 20, wherein the two integrated circuit devices are configured to transmit content of their respective first registers in VGPIO state information transmitted over the serial bus.

22. The apparatus of claim 20, wherein the second registers of the two integrated circuit devices are configured with two different values that are logical inversions of each other.

23. The apparatus of claim 20, wherein the output GPIO terminals in a first integrated circuit device correspond to the input GPIO terminals in a second integrated circuit device.

24. The apparatus of claim 23, wherein the input GPIO terminals in the first integrated circuit device correspond to the output GPIO terminals in the second integrated circuit device.

25. The apparatus of claim 20, wherein each integrated circuit device comprises a finite state machine adapted to:
detect physical state information of at least one output GPIO pin;
characterize the physical state information as virtual state information; and
cause the virtual state information to be transmitted over the serial bus.

26. The apparatus of claim 20, wherein each integrated circuit device comprises a finite state machine adapted to:
determine that input VGPIO state information directed to the at least one bit representative of the state of the input GPIO terminal has been received; and
cause the input GPIO pin to be driven in accordance with the input VGPIO state information.

27. A storage medium comprising instructions that, when executed by one or more processors, causes the one or more processors to:
store a plurality of virtual general-purpose input/output (VGPIO) bits in a first register, each VGPIO bit representing state of a physical general-purpose input/output (GPIO) pin in a first device, wherein the plurality of VGPIO bits includes one or more bits representative of state of output GPIO pins of the first device and at least one bit representative of state of an input GPIO pin of the first device;
receive first VGPIO state information from a serial bus, the first VGPIO state information being directed to the first register;
write a first set of bits of the first VGPIO state information to the first register when corresponding bits of a second register are configured with a first logic state; and
refrain from writing a second set of bits of the first VGPIO state information to the first register when corresponding bits of the second register are configured with a second logic state, wherein the second set of bits is directed to the one or more bits representative of state of output GPIO pins.

28. The storage medium of claim 27, wherein the instructions cause the one or more processors to:
configure the second register with a first masking value that corresponds to a configuration of input GPIO pins and output GPIO pins for which state is represented by the first register, wherein the second register is configured during initialization of the first device.

29. The storage medium of claim 27, wherein the first VGPIO state information is received from a second device, and wherein the second device includes a third register configured with a plurality of mask bits, each mask bit corresponding to a GPIO pin of the second device, and wherein the third register is configured with a mask value operable to prevent bits of second VGPIO state information from being written to a VGPIO register of the second device that maintains state of output GPIO pins of the second device.

30. The storage medium of claim 27, wherein the instructions cause the one or more processors to:
receive input VGPIO state information directed to the at least one bit representative of state of the input GPIO pin; and
drive the input GPIO pin in accordance with the input VGPIO state information.
